(19) United States
(12) Patent Application Publication
(10) Pub. No.: US 2008/0184937 A1
(43) Pub. Date: Aug. 7, 2008

(54) PET BOOSTER SEAT

(75) Inventors: Patrick Hoffman, Arlington, TX (US); David King, Allen, TX (US); Thomas B. Murphy, Arlington, TX (US)

Correspondence Address: CRUTSINGER & BOOTH, 1601 ELM STREET, SUITE 1950, DALLAS, TX, 752014744, US

(73) Assignee: Solvit Products, LP, Mansfield, TX (US)

(21) Appl. No.: 11/833,741

(22) Filed: Aug. 3, 2007

Related U.S. Application Data
(60) Provisional application No. 60/835,332, filed on Aug. 3, 2006.

(51) Int. Cl. A01K 29/00

(52) U.S. Cl. 119/28.5

(57) ABSTRACT

A pet booster seat to be secured to a generally vertical vehicle seat back is configured to support a pet elevated above a horizontal vehicle seat cushion. A basket assembly is formed by a rod configured to form an upper basket frame and a rectangular basket, having front and rear panels and right and left side panels, each of the panels being folded and sewn to form a casing envelope around the upper periphery of the basket for encasing the upper basket frame. The basket assembly is pivotally connected to a backboard having upper and lower edges and right and left side edges. Two support rods having lower ends pivotally secured to the backboard extend from adjacent a lower edge of the backboard upwardly to the upper basket frame. A pair of tubes is pivotally secured to the upper basket frame and telescopically receive upper ends of the support rods such that the support rods are aligned to the internal wire frame to stabilize the basket from below to provide an unobstructed view and a comfortable ride for the pet.

### CROSS-REFERENCE TO RELATED APPLICATIONS

Applicant claims priority of U.S. Provisional Application Ser. No. 60/835,332, filed Aug. 3, 2006

### STATEMENT REGARDING FEDERALLY SPONSORED RESEARCH OR DEVELOPMENT

Not applicable

### REFERENCE TO MICROFICHE APPENDIX

Not applicable

### TECHNICAL FIELD

A pet booster seat configured to fit on vehicle bucket seats and bench seats with headrest to elevate the pet so it can see out through the window of the vehicle.

### BACKGROUND OF INVENTION

Excited pets can be very distracting to the driver and can be especially dangerous if the pet interferes with access to the vehicle pedals or interferes with steering the vehicle. Pet restraining devices have been devised to control pets while being transported in vehicles. One is a harness that is useful on larger animals and the other is a basket-like carrier for smaller animals. Many of the basket-like carriers sit on the seat cushion while others are supported by the back of the seat.

Pet booster seats for elevating a pet so it can see out the window are currently in one basic format, a rectangular basket of material with some kind of internal frame, that is suspended from the seat back by means of a set of straps. The straps attach to the basket in several places and wrap around the back of the vehicle seat. In these designs, the basket generally has no structure of its own, other than the internal wire frame at the top rim of the basket. These devices rely on the straps to hold the basket up. This requires that the straps be fastened to the top of the basket, along the front edge, generally in two places. To keep the basket from rotating, a second set of straps is required at the bottom of the basket The problem with these designs is the straps fastened to the top of the basket invade the air space above the basket and get in the pet's way. Also, since the lower strap must go around the back of the vehicle seat, for all practical purposes, it cannot be attached to a bench-type vehicle seat, Since the back seat in most vehicles is of the bench-type variety, this means these booster seats must almost exclusively be employed in the front seat of the vehicle, and then only if the front seat is a bucket-type design. Another problem with these designs is they do not work well on seats that do not have adjustable head rests. On seats with integrated-headrests, the top straps tend to slide down the side of the seats thus failing to support the basket appropriately. To elevate the pet to a high position, the top straps must be tightened more and more, which tends to rotate the basket so the front edge is higher than the back.

### DESCRIPTION OF THE PRIOR ART

U.S. Pat. No. 3,310,034 discloses a safety harness and collar arrangement. One disadvantage of this device is that is allows the animal to sit directly on the seat fabric, thus leaving the seat open to damage by scratching: or soiling.

U.S. Pat. No. 5,005,526 discloses a collapsible animal seat supported on the vehicle seat cushion and anchored by a vehicle seat belt. It is closed in on all four sides which may obstruct air circulation and prevents the pet from seeing out of the vehicle windows.

U.S. Pat. No. 5,133,294 discloses a pet carrier for use in a vehicle having a platform sized to generally fit on a passenger seat of the vehicle. Front, rear and side panels are pivotally connected to the platform for movement between generally horizontal positions and upright positions wherein they form a pet enclosure upstanding from the platform. The rear panel, in its upright position, is much taller than the other panels, and is inclined upwardly and rearwardly to generally match the inclination of the back of the passenger seat. Connectors are provided for releasably retaining the panels in their upright positions.

U.S. Pat. No. 5,551,373 discloses a portable pet booster seat apparatus having a base portion that sits on the seat of a motor vehicle.

U.S. Pat. No. 4,597,359 discloses a platform supported on a seat cushion elevated by vertical and horizontal arms.

U.S. Pat. No. Des. 245,716 illustrates a car seat for domestic animals with four legs on the carrier which engage a vehicle seat cushion and a pair of hooks which appear to connect to the back of a seat.

U.S. Pat. No. 5,123,377 discloses a collapsible, folding vehicle seat and safety restraint apparatus for animals including a padded seat pivotally extended from a generally vertically disposed seat back which is removably affixed to an otherwise conventional vehicle seat back by a pair of suspension hooks. An adjustable animal restraint harness, such as a chain, is attached to the upper end of the apparatus seat back.

U.S. Pat. No. 2,869,146 discloses a platform for dogs which attaches over the top of a car seat. There is no means provided to secure the dog onto the platform in case of a sudden stop.

Booster seats for small animals heretofore devised have not been convenient to connect to the vehicle seat and have not been light weight and easily manipulated. The devises have been expensive and sometimes difficult to maintain.

Heretofore, no system has been devised for suspending a basket, forming a horizontal pet booster seat on a seat back, which is inexpensive, easily installed and configured to safely support the pet under normal driving conditions, without obstructing the view of the pet and the driver.

### SUMMARY OF THE INVENTION

The pet booster seat disclosed herein comprises a rectangular basket with an internal wire frame, which is attached at the upper back edge to a rigid backboard. At the bottom front of this backboard, at the extreme left and right sides, are two brackets which support two rods that further support the internal wire frame of the basket. By supporting the internal wire frame from below no straps need to be attached to the basket, thus leaving the space above the basket clear for pets to move about in the basket and see clearly. Also, this design needs only one strap to be installed, although generally, two are recommended, and thus can be hung from the adjustable headrest of a bench-type seat as easily as from a bucket-type seat, thus allowing it to be installed in most rear vehicle seats.

### DESCRIPTION OF THE DRAWINGS

Drawings of a preferred embodiment of the invention are annexed hereto, so that the invention may be better and more fully understood, in which:

FIG. 1 is a perspective view illustrating the front and left side of the pet booster seat installed on a vehicle seat with a dog in the seat;

FIG. 2 is a perspective view illustrating the front and left side of the pet booster seat installed on a vehicle seat;

FIG. 3 is a perspective view illustrating the front and right side of the pet booster seat installed on a vehicle seat;

FIG. 4 is a perspective view illustrating the front and right side of the pet booster seat;

FIG. 5 is a perspective view illustrating the rear of the rigid backboard;

FIG. 6 is a perspective view illustrating the bottom of the basket and front of the rigid backboard, showing the pivotal connection between the top edge of the basket and the upper edge of the backboard;

FIG. 7 is a perspective view illustrating the front and right side of the pet booster seat with a basket liner in the basket; and

FIG. 8 is an enlarged perspective view illustrating a connector tube mounted on the right side of the rigid basket support frame for receiving the upper end of the right support rod.

Numeral references are employed to designate like parts throughout the various figures of the drawing.

### DESCRIPTION OF PREFERRED EMBODIMENT

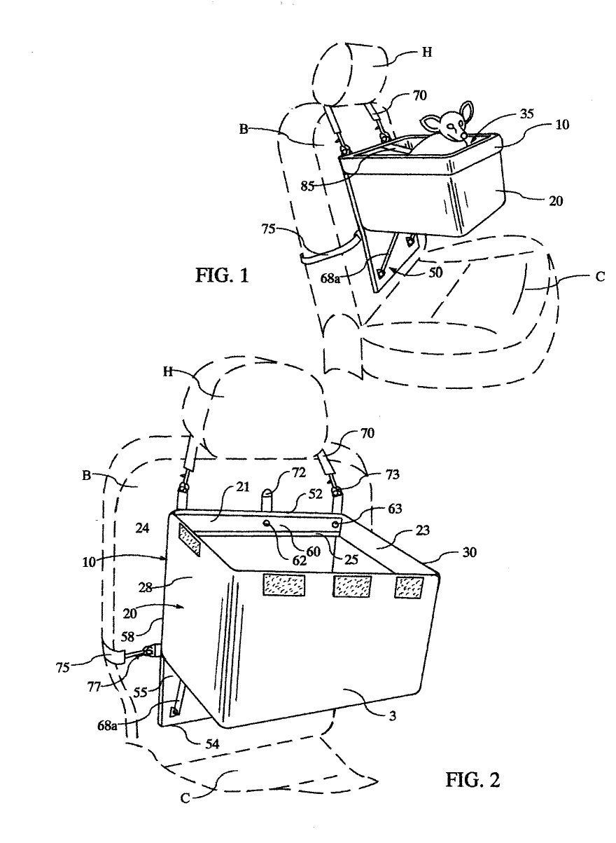

The pet booster seat, generally designated by the numeral 10 in the drawings, is configured to be secured to a generally vertical vehicle seat back B to support a pet elevated above a generally horizontal seat cushion C, as illustrated in FIG. 1. Seat 10 generally comprises a basket assembly 20 pivotally secured to a rigid backboard 50 with two support rods 66a and 68a pivotally secured to the backboard 50 and extending from the bottom of the backboard 50 to a basket frame 40. A short adjustable 1-inch wide strap 70 and a long adjustable 1-inch wide strap 75 are provided to suspend the backboard 50 from a headrest H on the generally vertical vehicle seat back B. An adjustable ½-inch wide tether strap 65 and a removable fabric basket liner 80 are provided to support and restrain the pet.

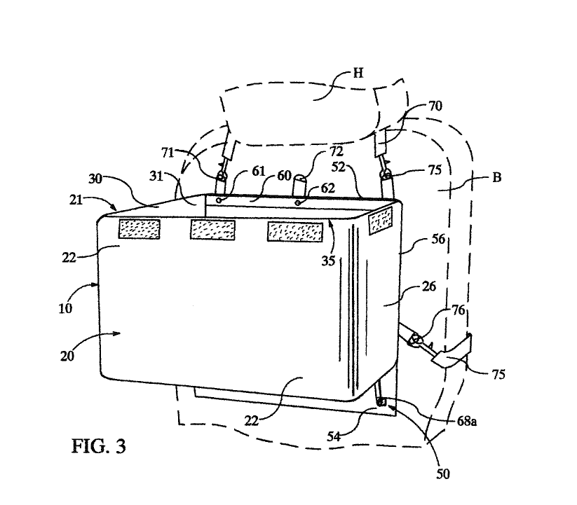

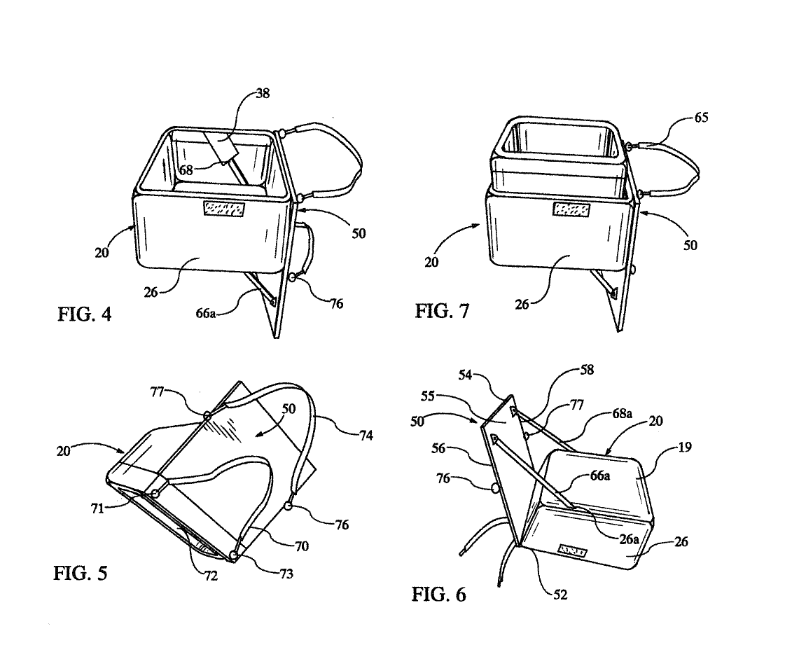

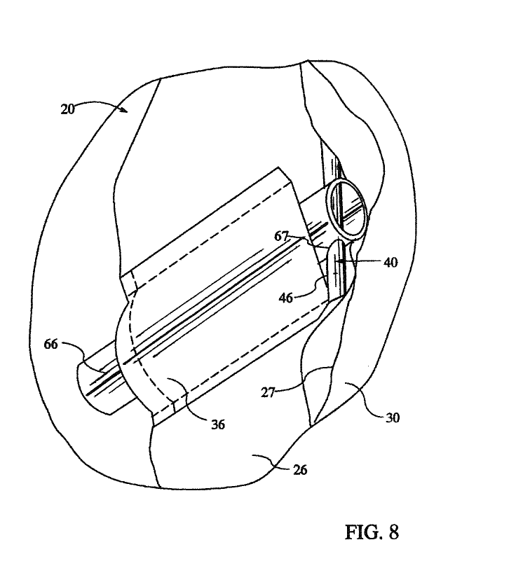

Referring to FIGS. 2-4 of the drawings, basket 20 is preferably formed of fabric or leatherette panels having a fold 21 forming a flap 23 extending along the upper edge of front panel 22, a flap 25 extending along the upper edge of a rear panel 24, a flap 27 extending along the upper edge of a right side panel 26, a flap 29 extending along the upper edge of a left side panel 28, the flaps 23, 25, 27 and 29 forming a casing envelope 30 which encircles the upper periphery 31 of basket 20. Pockets 36 and 38 are sewn on to side panels 26 and 28 to cover connector tubes 66 and 68 which receive support rods 66a and 68a, as shown in FIG. 8.

Flaps 23, 25, 27 and 29 are turned down on the upper edge of a basket to provide a finished edge, and extra fabric is left in the hem to form the casing envelope 30. As will be hereinafter more fully explained, a spacer bar 60 is secured by rivets 61, 62 and 63 through rear flap 25 to the backboard 50, the rivets extending through the backboard adjacent the upper edge 52 and through a panel 24 on basket 20 adjacent the upper periphery 31 of the basket to pivotally connect the basket to the backboard 50.

Basket frame 40 is formed by a rod 41 bent to provide a front panel support 42, a rear panel support 44, a right side panel support 46, and left side panel support 48. Rod 41 extends through and is encased in casing envelope 30 which encircles the upper periphery 31 of basket 20. Connector tubes 66 and 68 are hollow and drilled to form apertures 67 and 69 adjacent upper ends thereof through which rod 41 extends.

The pet booster seat 10 comprises a basket 20 having a floor 19 and an upper periphery 31 extending around an upper opening 35. The pet booster seat 10 further comprises a rigid generally vertically disposed backboard 50 configured for supporting the basket 20 and pet in an elevated position spaced above the generally horizontal seat cushion C. It is important that space above the basket 20 not be obstructed by braces, straps and other structures. It is also important that the basket 20 be firmly supported to maintain the floor 19 of the basket 20 substantially horizontal to provide an unobstructed view from the basket.

Backboard 50 has an upper edge 52, a lower edge 54, a right edge 56 and a lower edge 58 bounding a rigid body portion 55, which is preferably covered with fabric or leatherette panels.

Working one at a time, swivel the rods 66a and 68a into a vertical orientation and slip them into the slots 26a and 28a at the bottom edge of each side of the basket 20. The rods should be visible as they pass through to the inside of the basket. Carefully slide each rod into the plastic tube 66 and 68 located on the inside wall of the basket. After both rods 66a and 68a are fully inserted, push down on the basket floor 19 to make sure the seat is fully assembled and feels stable.

The removable fabric liner 80 has three slits 81, 82 and 83 located about 2 inches in from the back edge 84. The three slits 81, 82 and 83 should align with the three D-rings 71, 72 and 73 along the back edge 24 of the basket 20. Slip the liner 80 over the D-rings and wrap the other edges over the other three sides of the basket 20, taking care to line up the various hook-and-loop fasteners along each edge. Adjust the liner inside the basket for the best fit. To remove the liner for washing, follow the above steps in reverse order.

It should be appreciated that a rigid frame 40 encircles at least a major portion of the upper periphery 31 of the basket 20. In the illustrated embodiment, the frame 40 is a rod 41 bent to form supports 42, 44, 46 and 48 for panels 22, 24, 26 and 28 that extend between the upper periphery 31 and floor 19 of basket 20 as will be hereinafter more fully explained. However, it should be appreciated that the frame 40 may assume other and further configurations such as a generally U-shaped member having end portions for attachment to the backboard 50.

A backboard 50, having an upper edge 52 and a lower edge 54, supports the upper periphery 31 of the basket 20. In the illustrated embodiment, a spacer bar 60 is secured by rivets 61, 62 and 63 to the backboard 50, the rivets extending through the backboard adjacent the upper edge 52 and through a panel 24 on basket 20 adjacent the upper periphery 31 of the basket.

Other fastener means (not shown) may be employed for securing basket 20 to the backboard 50 such that the upper periphery 31 extending around the upper opening 35 in the basket 20 is positioned adjacent the upper edge 52 of the backboard 50 and such that the floor 19 of the basket 20 is supported above the lower edge 54 of the backboard 50.

Means is provided for suspending said backboard 50 from the generally vertical vehicle seat back B, said backboard 50 being raised vertically above the generally horizontal cushion C and positioned between said basket 20 and the generally vertical seat back B, such that said lower edge 54 of said backboard 50 and said floor 19 of said basket 20 are suspended above the generally horizontal seat cushion C.

Support rods 66a and 68a on backboard 50 extending below and behind the basket and are configured to firmly support the rigid basket frame 40 encircling at least a major portion of the upper periphery of the basket, such that space above the upper periphery of said basket is substantially unobstructed.

To align the support rods 66a and 68a to the internal wire frame 40, two small tubes 66 and 68 are installed on the wire frame 40 into which the two support rods 66a and 68a are fitted. Due to the rigid nature of the support rods, and the way the support rods are aligned to the internal wire frame, the support rods stabilize the basket.

Booster seat 10 can be installed in a high position on the seat, without the basket rotating (front edge lifting up). It stays in constant relative position to the backboard, regardless of how high on the seat back it is located.

To install the booster seat 10 to the vehicle's bucket seat, attach the shorter adjustable strap 70 to the two D-rings 71 and 73 on the top edge 24 of the bask-et 20 and slip the strap over the headrest H. Adjust this strap 70 to change the elevation of the booster seat. Attach the longer strap 75 to one of the D-rings 76 on the side 56 of the rigid backboard 50 and loop around the bucket seat B and attach to the D-ring 77 on the other side of the backboard 50. Tighten this strap to make sure the booster seat is secure.

If the bucket seat does not have a headrest, loosen the top strap and allow the Booster Seat to slide down the front of the bucket seat until the backboard is resting on the bottom seat cushion. Both straps will now be wrapping around the back of the bucket seat. Tighten both straps to secure the Booster Seat.

To install the Booster Seat on a bench seat (most back seats are bench-types), the seat must have headrests. Attach the shorter strap as described above for the bucket seat and wrap it around the headrest and adjust as necessary. The longer strap is not used on bench-seat applications.

The ½-inch wide tether strap 65 can be used as a lead to attach to the pet's collar or harness. Fasten one end of the strap to the harness and the other to the D-ring 72 on the center back of the basket.

Be sure that this strap is adjusted to a length short enough to keep your pet from jumping out of the basket. If the lead is too long, there is the danger that your pet can jump out of the basket with the lead still attached. A harness is recommended instead of a collar to secure your pet safely.

Terms such as “horizontal,” “vertical,” “up,” and “down” when used in reference to the drawings, generally refer to the orientation of the parts in the illustrated embodiment and not necessarily in the described orientation during use.

While preferred embodiments of the method and apparatus for forming a pet booster seat have been disclosed, it should be apparent that other and further embodiments may be devised without departing from the basic concepts of the invention.

It is to be understood that, while detailed descriptions of a preferred embodiment has been illustrated and described, the invention is not to be limited to the specific arrangement of parts and specific features herein described and illustrated in the drawing. Rather, the descriptions are merely of an exemplary embodiment of the invention, which may be embodied in various forms.

1. A pet booster seat to be secured to a generally vertical vehicle seat back configured to support a pet elevated above a generally horizontal vehicle seat cushion comprising:
a basket having a floor and an upper periphery extending around an upper opening;
a rigid frame encircling at least a major portion of said upper periphery of said basket;
a backboard having an upper edge and a lower edge;
means securing said basket to said backboard such that said upper periphery extending around said upper opening in said basket is positioned adjacent said upper edge of said backboard and such that said floor of said basket is supported above said lower edge of said backboard;
support means for suspending said backboard from the generally vertical vehicle seat back, said floor of said basket being raised vertically above the generally horizontal vehicle seat cushion and said support means being positioned between said basket and the generally vertical seat back, such that said floor of said basket is suspended above the generally horizontal seat cushion; and
means on said backboard extending below and behind said basket configured to firmly support said rigid frame, such that space above said upper periphery of said basket is substantially unobstructed.

2. A pet booster seat to be secured to a generally vertical vehicle seat back according to claim 1, said means securing said basket to said backboard such that said upper periphery extending around said upper opening in said basket is positioned adjacent said upper edge of said backboard comprising: means pivotally securing said basket to said backboard.

3. A pet booster seat to be secured to a generally vertical vehicle seat back according to claim 1, wherein the vehicle seat back has a headrest, said support means for suspending said backboard from the generally vertical vehicle seat back comprising: a strap secured adjacent said upper edge of said backboard and configured to extend around the headrest.

4. A pet booster seat to be secured to a generally vertical vehicle seat back according to claim 3, said strap secured adjacent said upper edge of said backboard having ends secured to spaced D-rings secured to said backboard.

5. A pet booster seat to be secured to a generally vertical vehicle seat back according to claim 1, wherein the vehicle seat is a bucket seat, said support means for suspending said backboard from the generally vertical vehicle seat back comprising: a strap secured adjacent said upper edge of said backboard and configured to extend around the generally vertical vehicle seat back.

6. A pet booster seat to be secured to a generally vertical vehicle seat back according to claim 5, said strap secured adjacent said upper edge of said backboard having ends secured to spaced D-rings secured to said backboard.

7. A pet booster seat to be secured to a generally vertical vehicle seat back according to claim 1, said means on said backboard extending below and behind said basket configured to firmly support said rigid frame comprising: support rods having lower ends secured to said backboard and upper ends secured to said rigid basket frame.

8. A pet booster seat to be secured to a generally vertical vehicle seat back according to claim 1, said support rods having lower ends pivotally secured to said backboard.

9. A pet booster seat to be secured to a generally vertical vehicle seat back according to claim 7, with the addition of a pair of hollow tubes secured to said rigid frame encircling at least a major portion of said upper periphery of said basket, said support rods having upper ends positionable in said hollow tubes.

10. A pet booster seat to be secured to a generally vertical vehicle seat back according to claim 1, said basket comprising front, rear and side panels; and wherein said means securing said basket to said backboard comprises: a spacer bar and fastener means for securing said spacer bar to said basket and to said backboard such that the upper periphery extending around the upper opening in the basket is positioned adjacent the upper edge of the backboard and such that the floor of the basket is supported above the lower edge of the backboard.

11. A pet booster seat to be secured to a generally vertical vehicle seat back according to claim 10, said fastener means comprising: rivets extending through the backboard adjacent the upper edge and through a panel and said basket adjacent the upper periphery of the basket to pivotally connect the basket to the backboard.

12. A pet booster seat to be secured to a generally vertical vehicle seat back according to claim 10, said means on said backboard extending below and behind said basket configured to firmly support said rigid frame comprising: support rods having lower ends secured to said backboard and upper ends secured to said rigid basket frame.

13. A pet booster seat to be secured to a generally vertical vehicle seat back according to claim 12, said support rods having lower ends pivotally secured to said backboard.

14. A pet booster seat to be secured to a generally vertical vehicle seat back according to claim 13, with the addition of a pair of hollow tubes secured to said rigid frame encircling at least a major portion of said upper periphery of said basket, said support rods having upper ends positionable in said hollow tubes.

15. A pet booster seat to be secured to a generally vertical vehicle seat back configured to support a pet elevated above a generally horizontal vehicle seat cushion comprising:
a rod configured to form an upper basket frame;
a rectangular basket having front and rear panels and right and left side panels, each of said panels being folded and sewn to form a casing envelope around the upper periphery of said basket for encasing said upper basket frame;
a rigid backboard having upper and lower edges and right and left side edges;
a spacer;
first and second upper connectors forming a pair of upper connectors, said pair of upper connectors being secured to said spacer and to said backboard adjacent said upper edge;
a strap having first and second opposite ends;
a fastener on said first end of said strap for detachably securing said first end to said first connector, said second end being connected to said second connector such that said strap supports said spacer, said backboard and said basket;
two support rods pivotally secured to the backboard and extending from adjacent said lower edge of said backboard upwardly to said upper basket frame; and
means detachably securing said support rods to said upper basket frame.

16. A pet booster seat to be secured to a generally vertical vehicle seat back configured to support a pet elevated above a generally horizontal vehicle seat cushion, according to claim 15, said means detachably securing said support rods to said upper basket frame comprising: a pair of tubes pivotally secured to said upper basket frame which telescopically receive upper ends of said support rods such that the support rods are aligned to the internal wire frame to stabilize the basket.
